(19) United States
(12) Patent Application Publication
(10) Pub. No.: US 2025/0165613 A1
(43) Pub. Date: May 22, 2025

(54) VULNERABILITY RESPONSE BASED ON INTERFACE INSTRUMENTATION

(71) Applicant: INTERNATIONAL BUSINESS MACHINES CORPORATION, Armonk, NY (US)

(72) Inventors: Max Fabian Gilbert, Ludwigshafen am Rhein (DE); Reinhold Geiselhart, Rottenburg-Ergenzingen (DE); Felix Beier, Haigerloch (DE); Knut Stolze, Hummelshain (DE)

(21) Appl. No.: 18/526,085

(22) Filed: Dec. 1, 2023

(30) Foreign Application Priority Data
Nov. 16, 2023 (GB) GB2317542.5

(51) Int. Cl. G06F 21/57; G06F 21/55; G06F 21/56

(52) U.S. Cl. CPC G06F 21/577; G06F 21/554; G06F 21/566

(57) ABSTRACT

A computer-implemented method for protecting a software code against a security vulnerability, wherein the software code comprises at least one software code component, some of which comprising a function call, whereby each function call represents a dependency is disclosed. The method comprises integrating a dependency profiler with the at least one software code component, intercepting, at runtime of the software code component, the function call to at least one API of the service component, thereby detecting dynamically dependencies, recording a sequence of usage of the detected dependencies in a profiler report, and performing a response action based on known vulnerabilities in the sequence of the usage of the detected dependencies

### BACKGROUND

Aspects of the present invention relate generally to a method for protecting software code from security vulnerabilities, and more specifically, to a computer-implemented method for protecting a software code from security vulnerabilities, the software code comprising at least one software code component, some of which comprise a function call, whereby each function call represents a dependency. Embodiments of the present invention relate further to a related runtime dependency security system for protecting a software code from security vulnerabilities, and a related computer program product.

When developing software, security aspects play a significant and ever-growing role. This is particularly true in the age of component-based development of software applications and development frameworks. Especially, the use of freely available and reusable software components of a development platform may open the door to vulnerabilities. These represent one of the biggest security risks in software development and deployment. A study was published back in 2014 that showed that around 80% of the code developed for applications comes from libraries and framework components.

This use of numerous third-party software components in “own code”—i.e., the individually developed code-implies that there are a large number of dependencies on one's own code and from called libraries to another layer of components and libraries. This way, many modern software products have hundreds or even thousands of immediate and transitive dependencies, all of which may represent security risks, i.e., vulnerabilities. Thereby, an immediate dependency describes a direct dependency, while a transitive dependency describes an indirect dependency.

Nowadays, tens of thousands of vulnerabilities are published each year as Common Vulnerabilities and Exposures (CVE). Developers of new application code face the problem of assessing a growing number of vulnerabilities in the dependencies of software applications and deciding whether these also affect their software.

In addition, a vulnerability in an immediate or transitive dependency does not automatically make all functions of a software product vulnerable. Many times, only certain API (application programming interface) parts of a software component are affected by a certain vulnerability. And even if the software product is affected by such vulnerability, only parts of its functions may be affected. Thus, users with workloads that do not use these functions do not need an update of the generally affected library or component immediately.

As a consequence, software developers must carefully read CVEs of dependencies, look for affected API parts and search through the own code whether those API parts would be called. This is tedious and very time-consuming for immediate dependencies but frequently impossible for transitive dependencies. For vulnerabilities in transitive dependencies, developers must either wait until the developers of the potentially affected immediate dependencies do this analysis and report which of their API parts are affected, or they simply cite that the software product is affected so they must update the vulnerable transitive dependency to a non-vulnerable version if possible.

Some methods to address this issue may attempt to detect vulnerability based on software dependency analysis. Thereby, the vulnerability detection method is used for analyzing a software dependency item quoted in the target software and a calling function thereof, inquiring vulnerability information in the software dependency item by using a public vulnerability information base, and performing joint analysis on the target software and the software dependence item by combining a control flow graph and a function calling graph to assess whether the vulnerability of the software dependency item affects the target software.

However, such methods may produce too many false negative and too many false positive vulnerabilities due to missing dynamic runtime information. Other methods may only allow a more coarse-grained analysis of vulnerabilities.

Hence, there is a clear need to have a better transparency in respect to used software components and libraries that may represent a vulnerability or even have a reliable alarm system to avoid these dangerous effects when using the respective software.

### SUMMARY OF THE INVENTION

According to one aspect of the present invention, a computer-implemented method for protecting a software code against a security vulnerability may be provided, wherein the software code comprises at least one software code component, some of which comprising a function call, whereby each function call represents a dependency. The method may comprise integrating a dependency profiler with the at least one software code component, intercepting, at runtime of the software code component, the function call to at least one API of the service component, thereby detecting dynamically dependencies, recording a sequence of usage of the detected dependencies in a profiler report, and performing a response action based on known vulnerabilities in the sequence of the usage of the detected dependencies.

According to another aspect of the present invention, a runtime dependency security system for protecting a software code against a security vulnerability, wherein the software code comprises at least one software code component, some of which comprising a function call to a service component, whereby each function call represents a dependency may be provided. The system may comprise one or more processors and a memory operatively coupled to the one or more processors, wherein the memory stores program code portions which, when executed by the one or more processors, enable the one or more processors to integrate a dependency profiler with the at least one software code component, to intercept, at runtime of the software code component, the function call to at least one API of the service component, thereby detecting dynamically dependencies, to record a sequence of usage of the detected dependencies in a profiler report, and to perform a response action based on known vulnerabilities in the sequence of the usage of the detected dependencies.

Furthermore, embodiments may take the form of a related computer program product, accessible from a computer-usable or computer-readable medium providing program code for use by or in connection with a computer or any instruction execution system by or in connection with a computer or any instruction execution system. For the purpose of this description, a computer-usable or computer-readable medium may be any apparatus that may contain means for storing, communicating, propagating or transporting the program for use by or in connection, with the instruction execution system, apparatus, or device.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered to be disclosed within this document.

The aspects of the present invention defined above, and further aspects of the present invention are apparent from the examples of embodiments to be described hereinafter and are explained with reference to the examples of embodiments to which the invention is not limited.

Preferred embodiments of the inventive concept will be described, by way of example only, and with reference to the following drawings to which the inventive concept—for which variations and at least partial substitutions exist—is not limited:

FIG. 1 shows a block diagram of an embodiment of the inventive computer-implemented method for protecting a software code against a security vulnerability.

FIG. 2 shows a block diagram of a common software development environment.

FIG. 3 shows how the dependency profiler is integrated into the software code component.

FIG. 4 shows a flow of functions/activities of the dependency profiler for calls from the own code to service components of immediate dependency.

FIG. 5 shows a flow of functions/activities of the dependency profiler for calls from the own code to service components of transitive dependency.

FIG. 6 shows a flow of functions/activities of the dependency profiler for an exemplary interception of an API call.

FIG. 7 shows a flow of activities of the generated wrapper code with a blocking feature for calls of API parts with known vulnerabilities.

FIG. 8 shows an exemplary machine-readable JSON representation of a usage-pattern for Cyrillic characters.

FIG. 9 shows a block diagram of an embodiment of the inventive runtime dependency security system for protecting a software code against a security vulnerability.

FIG. 10 shows an embodiment of a computing system comprising the runtime dependency security system according to FIG. 9.

### DETAILED DESCRIPTION

Embodiments of the present invention can be described as follows:

According to one embodiment of the present invention, a computer-implemented method for protecting a software code against a security vulnerability, wherein the software code comprises at least one software code component, some of which comprising a function call, whereby each function call represents a dependency may be provided. The method may comprise integrating a dependency profiler into the at least one software code component, intercepting the function call to at least one API of the service component at runtime of the software code component, thereby dynamically detecting dependencies, recording a sequence of usage of the detected dependencies in a profiler report, and performing a response action based on known vulnerabilities in order in which the detected dependencies are used.

According to another embodiment of the present invention, a runtime dependency security system for protecting a software code against a security vulnerability, wherein the software code comprises at least one software code component, some of which comprising a function call to a service component, whereby each function call represents a dependency may be provided. The system may comprise one or more processors and a memory operatively coupled to the one or more processors, wherein the memory stores program code portions which, when executed by the one or more processors, enable the one or more processors to integrate a dependency profiler into the at least one software code component, to intercept the function call to at least one API of the service component at runtime of the software code component, thereby detecting dynamically dependencies, to record a sequence of usage of the detected dependencies in a profiler report, and to perform a response action based on known vulnerabilities in order in which the detected dependencies are used.

The proposed computer-implemented method for protecting software code from security vulnerabilities may offer multiple advantages, technical effects, contributions and/or improvements:

The numerous advantages of the concept proposed here address major shortcomings of known techniques for detecting whether a software product may be affected by a known vulnerability and dependencies, such as: Open-source scanning services, like Mend (compare, https://www.mend.io) or Prisma Cloud Software Composition Analysis which are static code analysis tools that scans and analyzes code bases and build artifacts—e.g., container images—for used/contained open-source components and compares those against CVEs from public CVE databases. Due to the dynamic behavior of the dependency profiler, which is not taken into account by the static tools, such tools would cause many more false positives and therefore higher maintenance/update overhead compared to the new conceptual approach described in this document. One of the differences may lay in the fact that the static tools do not know and takes into account whether affected API parts are actually called at one time or not. For technical reasons, these tools have no information about the actual usage of API parts at runtime.

Other known approaches like the LD_PROFILE environment variable by dynamic linkers in Linux and/or Solaris operating systems could be extended to preview some sort of wrapper code. However, it would be necessary to specify all the dynamic libraries that need to be profiled in the LD_PROFILE environment variable and consolidate the procedure call profiles generated by the linker-generated wrapper code. This is a clear limitation and thus a clear disadvantage if compared to the flexible response action, as described as part of the inventive concept.

Furthermore, a web application firewall (WAF) may also allow the filtering of requests to an HTTP-based API like a REST API. It is intended to block malicious traffic from and to public available web services that may have vulnerabilities, e.g., due to improper input validation. However, it is not intended to be used for REST APIs called internally by a software product as the developer of such a product would not expect API calls from their own application (under their control) are malicious. They use case therefore is different from that described in this document and the functionality of the newly proposed concept is also advantageous over a WAF.

Furthermore, modern operating systems (OS), such as Android, IOS or macOS may allow users to grant/revoke specific applications to use specific OS APIs. If a user would not grant access to the camera to a certain app, this app cannot access camera images. If the user does not grant access to his contacts to an app, it cannot read the list of contacts. This access control features are intended to give the user control over their privacy, especially when using untrusted or unknown applications. However, they cannot be used to block calls to vulnerable API parts of third-party components as these components are typically ship with the application. Hence, those API calls are application-internal and not under the control of the operating system. As a consequence, such techniques cannot successfully be used for a defense against security issues and vulnerabilities, as described by the inventive concept.

Hence, the value and the advantages of the concept proposed here may lay in preventing security issues due to vulnerabilities in the case of high complex and security-critical software products with many dependencies that must not be exploited at any cost. So, up to now, many thousands of working hours each year may be spent assessing known vulnerabilities that can potentially be exploited in application software. With the tool and concepts described in the document at hand, the effort required for this could be drastically reduced and software developers would be able to react more quickly to critical vulnerabilities. So, the overall software security and/or IT security would be enhanced.

The increased security of software products that integrate the dependency profiler with extensions as discussed below is also a great advantage for end-users of software products, especially, if the software handles highly sensitive data like sensitive personal information related to, e.g., the Health and Insurance Portability and Accountability Act (HIPAA). A data breach of such data via a known vulnerability may be way more costly—e.g., in terms of monetary and reputational costs-then having an outage due to blocking potentially or clearly vulnerable API calls. So, even if the dependency profiler would not be integrated throughout a software product, it could be valuable to integrate the wrapper code into the code path that handles such highly sensitive data. The advantage of such integration would lie in the selectable and configurable overhead costs due to the additional code implied by the dependency profiler and/or wrapper code.

In the following, additional embodiments of the inventive concept-applicable for the method as well as for the system-will be described.

According to a useful embodiment, the method may also comprise performing the response action if the scoring value of the dependency is larger than a predefined threshold value. The scarring value may be extracted from a Common Vulnerability Scoring System (CVSS). Additionally, different response actions may be performed depending on different predefined threshold values. The respective selection may be based on predefined rules, e.g., in the form of a company policy. Such company policy may be seen as second structural layer for a reaction type regarding security vulnerabilities.

As an example, if the scoring value has a range from 0 to 10, the scoring value may have, e.g., four ranges: LOW (0.1-3.9), MEDIUM (4.0-6.9), HIGH (7.0-8.9), and CRITICAL (9.0-10.0). Using these ranges, a user information may be generated for the MEDIUM range, a warning may be generated for the HIGH range and a shutdown of the software code could be initiated if the scoring value is in the CRITICAL RANGE. Additionally, an information about a potential security vulnerability may be generates for the development staff in the LOW range. However, also any other type and combination of response actions and scoring values may be configured.

According to an advantageous embodiment of the method, the performing of the response action may comprise determining a reaction type depending on the scoring value of a predefined sequence of dependencies. It may be noted that this kind of reaction type is different compared to the reaction type described above, as here, the respective scoring value depends on the sequence of function calls. The potential exploit of a vulnerability that requires a sequence of function calls may only be detected if the last function call of the sequence occurs. This may then again be a trigger for the determination of a combined scoring value based on, e.g., the CVSS (and/or other public and nonpublic information) of the vulnerability that can be exploited by the given sequence of function calls. And, depending on the scoring value, the reaction type is determined and performed.

According to another advantageous embodiment, the method may also comprise retrieving information about known vulnerabilities—in particular, from a database, e.g., from the service component provider or another public data source-including information about dangerous sequences of dependencies having a potential for causing a security issue with one or more of the directly or indirectly called service components.

According to a further developed embodiment, the method may also comprise retrieving information about known vulnerabilities—in particular, from a database, e.g. from the service component provider or another public data source-including information about dangerous function call parameter values, each of which being indicative of a potential security issue with the service component. This embodiment may go beyond the embodiment described in the previous paragraph as the here retrieved information is directed to function call parameter values and not only to the sequence of dangerous dependencies. However, both embodiments may advantageously be combined.

According to another advanced embodiment, the method may also comprise marking—e.g., in a profiler report or elsewhere-a service component relating to the dependency—i.e., a called service component—as to be updated depending on the reaction type. The update may be performed at a later point in time, e.g., if a new version of the called service component becomes available. This mechanism may be used for transitive and immediate function calls.

According to a preferred embodiment of the method, the integrating a dependency profiler with the at least one software code component may comprise generating the wrapper code for a called library—in general, all libraries and functions linked together—dynamically. This way, service component specifics may be addressed directly by the dependency profiler. Furthermore, this may also be performed at runtime. Additionally, and in order to avoid a too strong degradation of performance values of an application surveilled in the proposed way, it may be configurable which type of service component shall be wrapped with the wrapper code. For service components that are known not to represent a vulnerability, the wrapper code is not necessary.

According to a further permissive embodiment of the method, the reaction type may comprise at least one from the group consisting of: generating an alert, blocking an API specific functionality of the software code component, blocking the function call to the service component, terminating an execution of the software code component, marking the dependent component as “to be updated”, and changing a function call sequence, thereby circumventing a vulnerability. Hence, a large plurality of reaction types exists. The different options may be configurable and adaptable to different types of software code, i.e., applications. This configuration may be company-specific or rule-based or policy-based. Furthermore, the reaction type may also be based on a replacement of a function called having a known vulnerability. This may include a replacement of the function call by a newer version for the same function call or a call to a functional equivalent of the function library or service code component.

A real-world example may illustrate one of the options: The software code component could be a document management system that allows printing. The printing may require a printer driver as service component. If there is a vulnerability in the printer driver, the “printing” functionality of the document management system would be blocked (e.g., a greyed-out UI button).

According to a further advanced embodiment of the method, the dependency profiler or specific wrapper code may be enabled to change function call arguments for a function call to the service component if values of the function call arguments-which may also be only one—are known to be vulnerable for the software code. This knowledge may stem from an accessible CVE report. A simple and potentially successful change of the content may be to replace commas of CSV (comma separated variables) data by semicolons. Other replacement techniques will be known by a skilled person. Hence, one has an argument-based interception. This may be a pretty powerful vulnerability management approach addressing highly sophisticated security issues.

According to another enhanced embodiment of the method, the dependency profiler or specific wrapper code may be enabled to change the sequence of function calls to the service component if specific sequences of function calls are known to be vulnerable for the software code. Again, this knowledge may stem from a CVE report. This may be securely implemented if there is a functionally equivalent sequence of calls that does not expose the vulnerability, e.g., a sequence of calls with an additional call that allocates or otherwise discards a resource that is not specifically required.

According to an optional embodiment, the method may also comprise allow-listing (i.e., from which no security vulnerability may originate) a function call in case a vulnerability for values of the function call arguments are known. This may be performed if these values have never been used, as workaround exists in the own code. This way unnecessary overhead by the dependency profiler may be avoided.

In the context of this description, the following technical conventions, terms and/or expressions may be used:

The term ‘software code’ may denote any code that can be made executable and which is dependent on other code, e.g. in the form of libraries, subroutines, services in the sense of an service-oriented environment—e.g., cloud service functions—or code that is intended to be a software product. Hence, any software application code—like someone's own application or own code—e.g., such as a software application individually written by an IT department of an enterprise, a governmental body, or any other institution.

The term ‘vulnerability’ or in its longer notation ‘security vulnerability’ may denote here an IT-oriented term in the sense of flaws that may weaken the overall security of the device or system. Vulnerabilities can be weaknesses in either the hardware itself or the software that runs on the hardware. Vulnerabilities can be exploited by a threat actor, such as an attacker, to cross privilege boundaries (i.e., perform unauthorized actions) within a computer system. To exploit a vulnerability, an attacker must have at least one applicable tool or technique that can connect to a system weakness. In order to immunize a device or system against a vulnerability a dedicated vulnerability management including defense actions may be required, at least one of which is discussed as the inventive concept proposed within this document.

The term ‘software code component’ may denote software code of the software product, a software application, or a top layer of a certain functionality of it. So, the proposed dependency profiler may be implemented and used by developers of commercial software applications, real-time applications, or apps for mobile devices, as well as by developers developing individual software, e.g., for a single user group, e.g., a single enterprise.

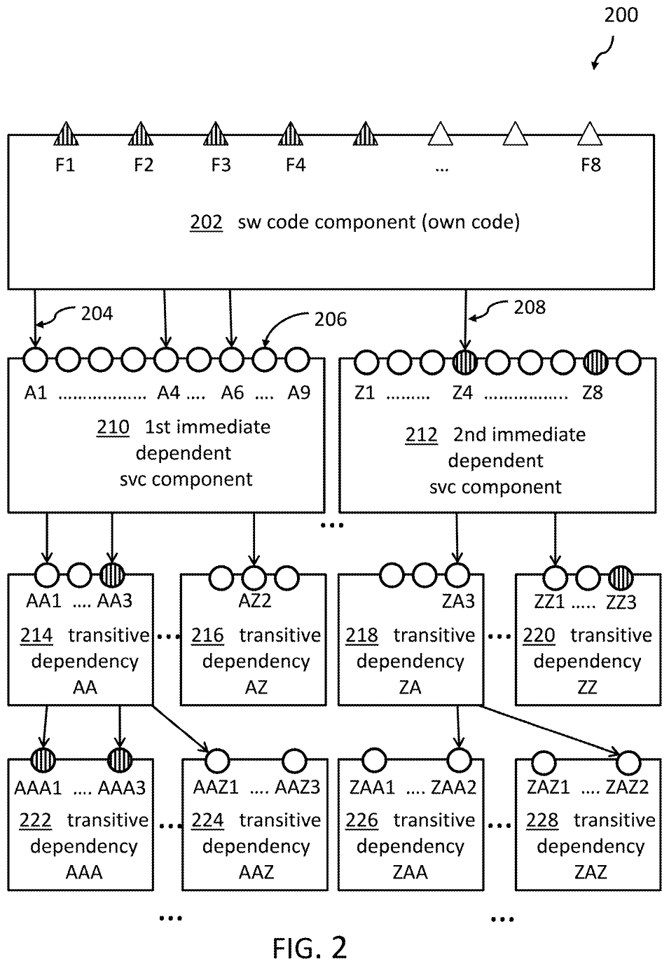

The term ‘function call’ may denote any access with or without function arguments to an immediate or transitive dependent software or service component. More details are discussed in the context of FIG. 2.

The term ‘service component’ may denote a type of dependency, either direct or indirect (i.e., immediate or transitive) because the service component or software service component may be called by “own code”.

The term ‘dependency’ may denote here a sub-ordinate software functionality—e.g., implemented as software service, subroutine, library, software function (in the sense of a callable, executable module) from which an upper-level software code component may be dependent. More details are discussed in the context of FIG. 2.

The term ‘dependency profiler’ may denote a function-being implementable as software, hardware, or a combination thereof-adapted to (besides others) intercept any call to a lower-level software code component than the calling software code. The dependency profiler may also be a surveillance function between a calling function and a called function, library, or the like. The dependency profile may use wrapper code dynamically which may be configured around existing software representing immediate and/or transitive dependencies.

The term ‘detecting dynamically dependencies’ may denote the ability to detect at runtime of a software system—e.g., a software product, a software application, software services, etc.—a software code (executable) that is called by the higher-level software code. I.e., software code from which at least the highest-level software code is dependent. Thereby, one may differentiate between immediate or direct dependencies and transitive or indirect dependencies.

The term ‘response action’ may denote any measure or action taken in order to counteract security vulnerabilities. A plurality of response action may be possible from simple warnings to a termination of the complete software application.

Before continuing with a detailed description of the Figures, a more general description of some reaction types shall be discussed: A comparably easy or lightweight countermeasure for vulnerabilities and the basis for further countermeasures is the automatic detection of dependency files. To ease the integration of the dependency profiler for the developers, it could be extended by an automatic detection of immediately and transitively used libraries, etc. With this extension, a developer would simply configure the files that make up their own code and the dependency profiler would generate wrapper code at runtime for all libraries and/or frameworks directly called by those files. The same could then also be done for all the libraries and/or frameworks called by those directly use dependencies so that transitive dependencies are also covered by the proposed concept.

Next, an alerting based on known vulnerabilities is addressed. The usage of dependencies may change with a new versions of the software product, i.e., a new version of the own code. Generally, the following could happen (example):
1. A vulnerability in a dependency of a software product is reported.
2. All usage reports of the lightweight dependency profiler integrated into that software product are scanned for calls of the API parts affected by the reported vulnerability.
3. No calls of the affected API parts by that software product can be found.
4. The software product is considered unaffected, and the vulnerable dependency is not updated to an unaffected version.
5. A new version of the software product calls the affected API part and thus, becomes itself vulnerable.
6. No re-assessment whether the software product is affected by this vulnerability is done since it was previously found out to be not affected.

To fix this problem, the dependency profiler would be enhanced by an alerting mechanism that can be configured with known vulnerabilities in used dependencies. The above example would then look as following (changes are shown in bold characters):
1. A vulnerability in a dependency of a software product is reported.
2. All usage reports of the dependency profiler integrated into that software product are scanned for class of the API parts affected by the reported vulnerability.
3. No calls of the affected API parts by that software product can be found.
4. The software product is considered unaffected, and the vulnerable dependency is not updated to an unaffected version.
5. The API parts affected by the reported vulnerability are marked as “vulnerable” in the configuration of the dependency profiler.
6. A new version of the software product calls the affected API parts and thus, becomes vulnerable itself.
7. The dependency profiler actively warns the developer, a tester, a user, or a DevOps operator of the software product about the call of a vulnerable API part.
8. The software product is considered affected by this vulnerability and the dependency is updated to an unaffected version.

Another embodiment of the proposed inventive concept may be in terminating a software product based on a vulnerable API call. In order to prevent any security incident based on newly found vulnerabilities, the dependency profiler could be further extended to completely terminate the respective software application, both, in test and production environments, whenever an API part is called that has a known vulnerability of a configurable common vulnerability scoring system (CVSS) threshold value. If the CVSS value is below this threshold value, and the developers, testers, users and/or DevOps operators of the respective software application (product) are still only alerted or informed, wherein a separate CVSS threshold value for warnings—i.e., a higher threshold level-could be configured.

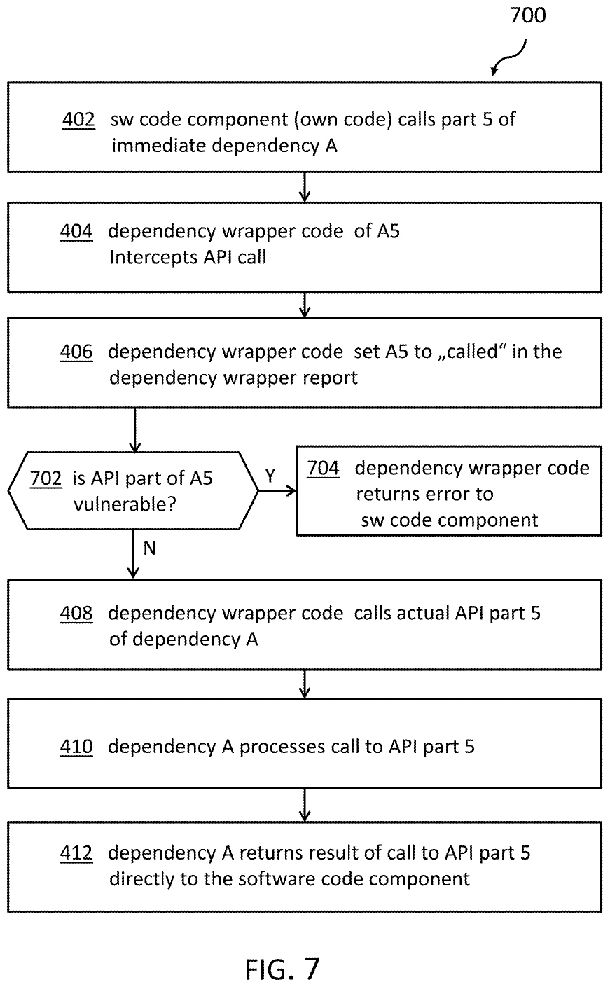

Furthermore, in another embodiment, vulnerable API calls can also be blocked. This example will be discussed in the context of FIG. 7.

In an even more sophisticated embodiment, vulnerable software product functionality can be blocked entirely. This may also be seen as a mitigation action against blocking API calls. They may lead to an unexpected behavior of the software application if no proper error handling is implemented. The users of the software product may be encounter cryptic error messages in the products user interface.

So, if the developer of a software product identifies a certain functionality or their product has affected by known CVEs, he could insert handler code into the user interface of the product that allows the blocking of certain functionality early—i.e., before the affected API parts of the vulnerable dependency are tried to be called. So, clear and precise error messages could be presented to the user.

This handler code could also use a similar concept as the one described in the context of an alerting based on public CVE databases. It could connect an API provided by the software developers of the software product where real-time information about to-be-blocked functionality of the software product can be retrieved.

Furthermore, argument- and state-based assessments as well as allow-listing approaches are also possible in additional embodiments that will be discussed in the context of the following Figure description.

In the following, a detailed description of the Figures will be given. All instructions in the Figures are schematic. Firstly, a block diagram of an embodiment of the inventive computer-implemented method for protecting a software code against a security vulnerability is given. Afterwards, further embodiments, as well as embodiments of the runtime dependency security system for protecting a software code against a security vulnerability will be described.

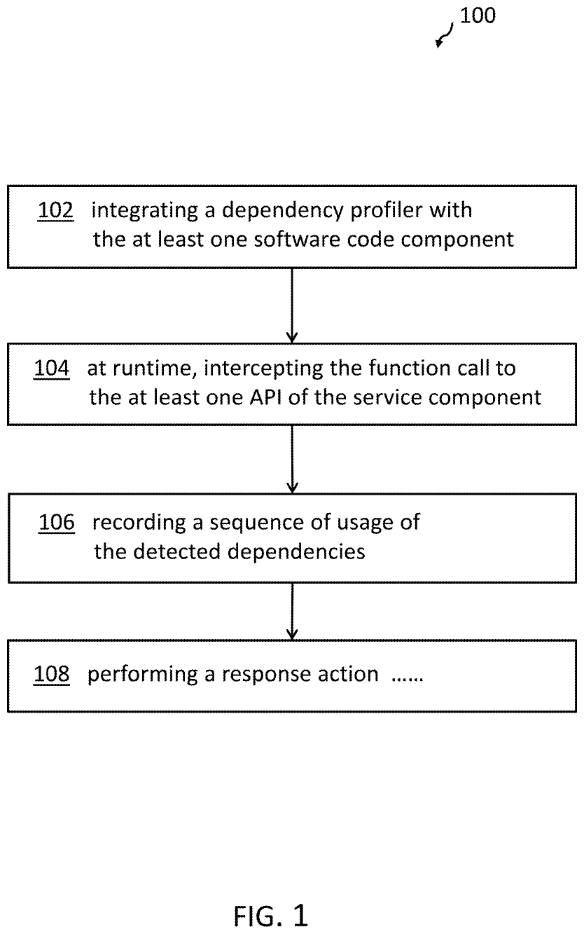

FIG. 1 shows a block diagram of a preferred embodiment of the computer-implemented method 100 for securing a software code against a security vulnerability where the software code comprises at least one software code component (typically more than 1). Some of the software code components comprise a function call, where each function call represents a dependency. The function calls can also be cascaded. The method 100 comprises integrating, 102, a dependency profiler—in particular, a wrapper code of the dependency profiler—with the at least one software code component. This can, e.g., happen at compile, link time and/or load time. Compiled executables can for example load any dynamic library using the dlopen( ) call. This allows the usage of a dynamic library that is not available at link time. In case of an interpreter instead of compiler, it may happen at load time. Also, in this case one would typically use a wrapper code around the software code component.

The method 100 further comprises intercepting, 104, the function call to at least one API of the service component at runtime of the interpreted or compiled and linked software code component, thereby recognizing dynamic dependencies that may be both immediate/direct and transitive/indirect.

Additionally, the method 100 comprises also recording, 106, a sequence of usage of the detected dependencies—i.e., the API calls itself or data exchanged using the API calls—in a profiler report, and performing, 108, a response action based on known vulnerabilities in the sequence of the usage of the detected dependencies. The response action could be graded depending on a severity of the vulnerability.

FIG. 2 shows a software product 200 comprising own code—i.e., software code component 202—and numerous third-party software components 210, 212 and 214, . . . , 228 and the dependencies between those. The first immediate dependent service component 210 and the second immediate dependent service component 212, exemplary representing dependencies (A . . . Z). Service components denote here executable software components and libraries in, e.g., a service-oriented architecture. These directly or immediately dependent service components can also depend on several other components (AA . . . ZZ, AAA . . . ZAZ) making them transitive dependencies for the own code. These transitive dependencies are represented by the boxes with reference numerals 214, . . . , 228.

Thereby, the API of a software component is comprised of several API parts, e.g., A1 to A9 shown as circles of the first immediate dependent service component 210 (compare arrow 204, 206, . . . ). Each API part could be, e.g., a single public method or variable of a Java class. But it could also be a single HTTP method or part of a REST-API (like GET/api/images) for a component that exposes a RESTful web interface.

The functions available through the software code component 202, i.e., the own code, is shown as a plurality of triangles F1, . . . , F8 at the top side. Thereby, vertically striped triangles represent potentially vulnerable functions of the software code component/own code.

However, a vulnerability in an immediate or transitive dependency does not automatically make all functions of a software product vulnerable. Many times, only certain API parts of a software component are affected by a certain vulnerability. And even if the software product is affected by such a vulnerability, only a subset of its functions may be affected. This is shown by the arrow 208, i.e., a call from the software code component 202 to an API part-shown as circle—of the second immediate dependent service component. Exemplary, this API part is shown as vulnerable API part Z4. Other potentially vulnerable API parts are shown as AA3 of transitive dependency 214, ZZ3 (which will never be called [no calling-arrow]) of transitive dependency 220, AAA1 and AAA2 of the transitive dependency 222. The other service components 216, . . . 220 as well as 224, . . . , 228 should be self-explanatory.

It is also clear that dependency Z8 of the second immediate dependent service component 212 will never be called by the own code 202. However, the dependency ZA may make the functions F1, . . . , F5 of the software code component 202 vulnerable as well.

This multitude of dependencies seems manageable if limited to the 10 dependent service components shown here. However, modern software products have hundreds or even thousands of immediate and transitive dependencies. Therefore, reviewing, assessing, and tracking every dependency for a potential vulnerability to the software product 200 is practically impossible. Especially, the dynamic nature of dynamically called libraries and service components makes it practically impossible to guarantee secure code.

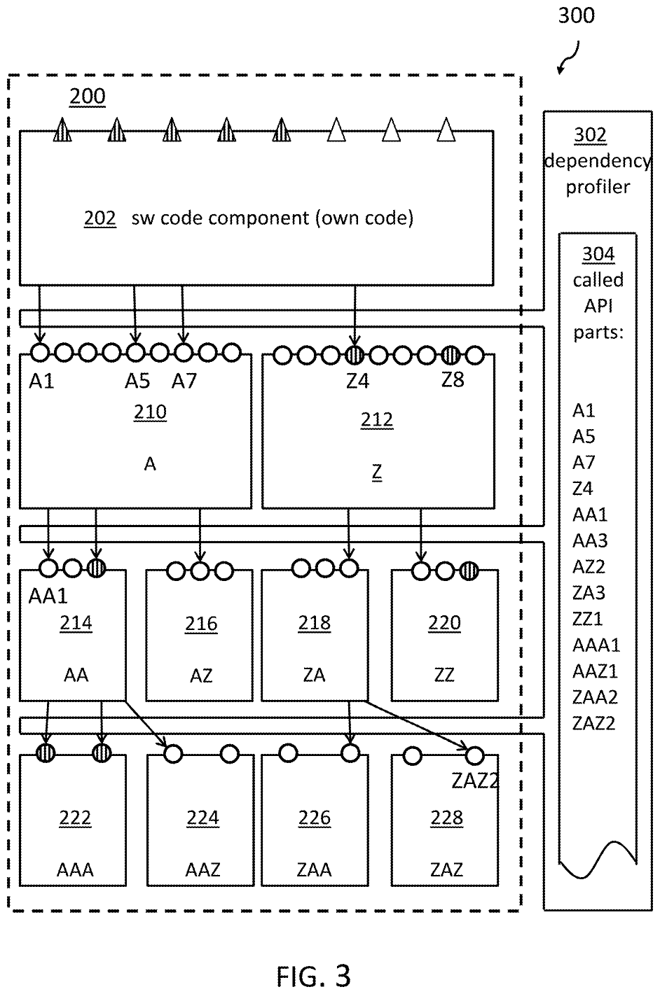

FIG. 3 shows a diagram 300 of how the dependency profiler 302 is integrated into the software code component 202 (own code). The left side of the Figure is basically a repetition of the dependencies discussed in the context of FIG. 2. The dependency profiler 302 may be implemented as a lightweight dependency profiler meaning that it may only represent limited overhead for the executing software product 200.

This dependency profiler 302 is adapted to intercept all calls to the API parts of all intermediate and transitive dependencies and record their usage. Hence, the called API parts comprise in this exemplary case A1, A5, A7, Z4, AA1, AA3, AZ2, ZA3 ZZ1, AAA1, ZAA2, and ZAZ2, as shown, which becomes obvious if read in the context of FIG. 2.

So, if a vulnerability in component ZZ's API part ZZ3 (compare transitive dependency ZZ 220) is found, a developer can simply scan the report of the dependency profiler 302 on test and production systems to discover that this API part is never used. So, any effect of this vulnerability can be ruled out for the current version of the application software.

However, scans of those profiler reports, triggered when a CVE was published regarding a vulnerability of component AA's function AA3 show that this API part is transitively called. Thus, the software product is likely affected by this vulnerability and the component must be updated as soon as a version without this vulnerability becomes available.

The fact that no report on any test or production system shows a certain, vulnerable API call does not guarantee that the software product has not called that vulnerable API part in any situation, e.g., during error handling, because not all possible code path were executed on these systems. The dependency profiler could therefore alert users, developers, and DevOps operators about vulnerable API calls at run time if configurable or automatically imported information about known vulnerabilities is added to it. It could also prevent these vulnerable API calls to further increase the security of the software product.

In order to further decrease false positives—i.e., vulnerability detected although not existing—the dependency profiler could also generate an alert or block a function based on usage patterns rather than single API calls. This is a benefit for all the vulnerabilities in dependencies that require a certain sequence of API calls of sequence of arguments to API calls to be exploited.

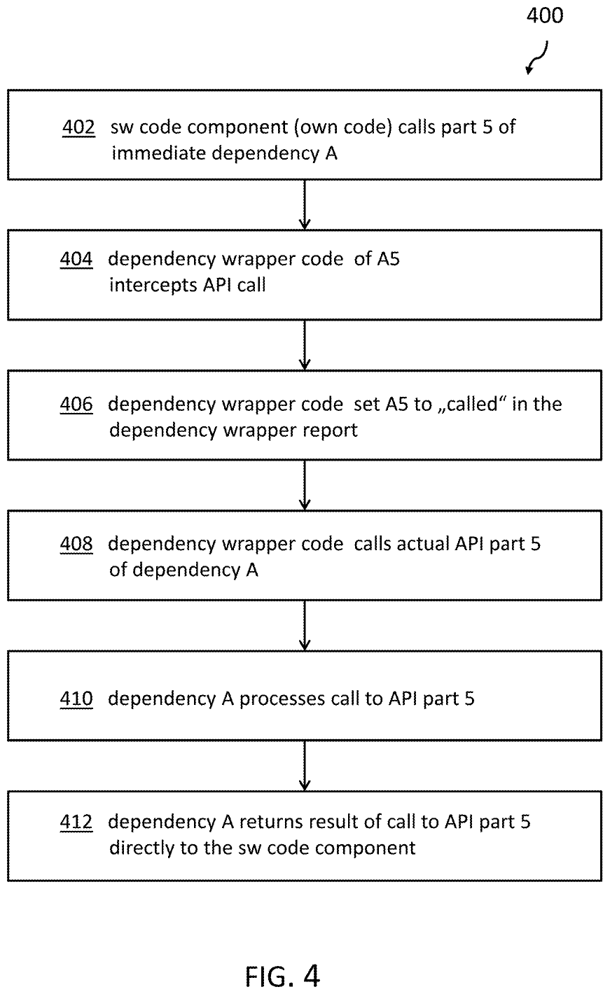

FIG. 4 shows a flow 400 of functions/activities of the dependency profiler for calls from the own code to service components of immediate dependency. This is based on a useful set of features for the dependency profiler:
(i) a manually configurable set of dependency files—like dynamic libraries, .jar files, etc.—that need to be profiled,
(ii) an automatically generated wrapper called around the functions and those libraries that record a usage of the different usage service components and dependencies,
(iii) wrapper code and call intercepts should work with different technologies like shared objects, Java classes loaded using ClassLoader, Perl modules, Python packages, bash scripts REST APIs, etc.; thereby, tools for aspect-oriented programming could be used,
(iv) a function for retrieving the recorded function usages, which could be as simple as a report file.

The functions of the flow 400 start in this example with a calling of the immediate dependency A by the own code, 402. In other examples that dependencies will be called. Then, the wrapper code of A5 intercepts in this API call, 404. The wrapper code of the dependency profiler sets the API part A5 to the status “called” in the dependency profiler report, 406. Next, the wrapper code calls the actual API part A5 of the dependency A, 408. Subsequently, the dependency A—i.e., the called service function or library-processes the call to the API part A5, 410. Last but not least, the dependency A, i.e., the respective software component/service function returns a respective result of the call to the API part A5 directly to the own code, 412. Hence, the call/return sequence is asymmetric: (i) the call is intercepted, and (ii) the return value is delivered directly to the calling function. It may again be noted that this flowchart illustrates the interception of an API call to A5 from the own code. For other API calls, other interfaces would be used.

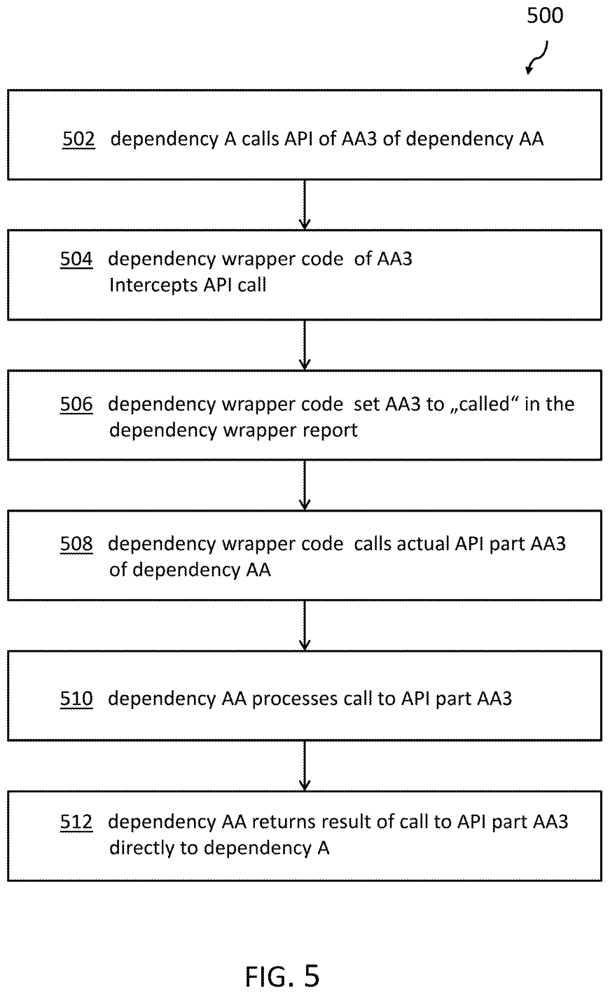

FIG. 5 shows a flow 500 of functions/activities of the dependency profiler for the exemplary interception of an API call to AA3 from dependency A, i.e., a transitive dependency. Firstly, dependency A- or better the respective service function or library—calls the API part AA3 of the dependency AA, 502. Then, the wrapper code AA3 intercepts the actual API call, 504. Next, the wrapper code sets, 506, the component AA3 to “called” in the dependency profiler report. As next step, the wrapper code calls the actual API part A3 of dependency AA, 508. Furthermore, the dependency AA processes the call to the API part AA3, 510, and the dependency AA returns the result of the call to the API part AA3 directly to the dependency A, 512.

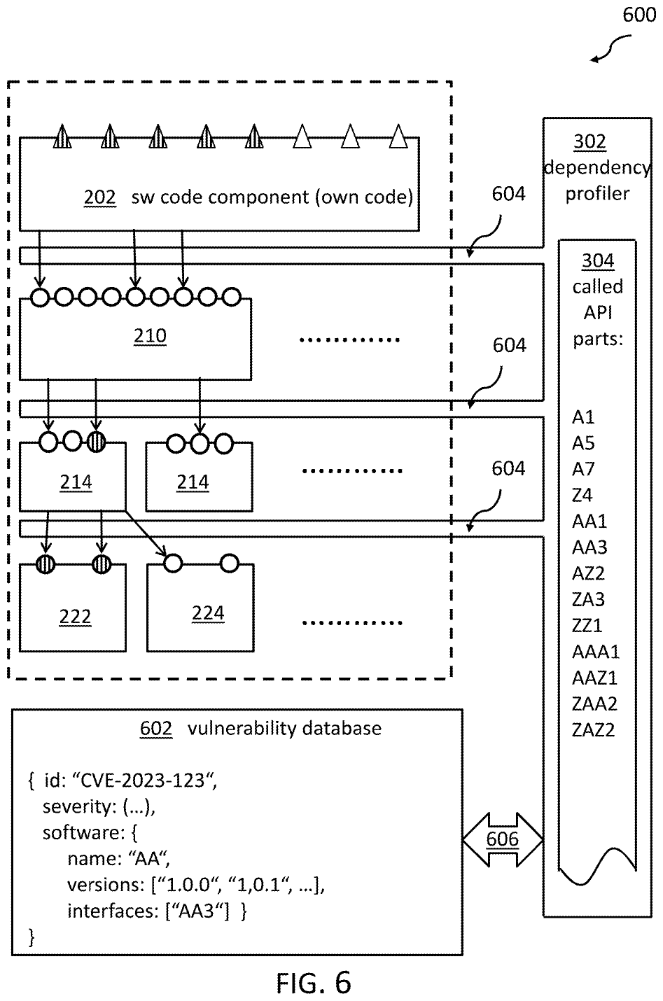

FIG. 5 and FIG. 6 visualize the general flow (compare 600 in FIG. 6) of the generated wrapper code 302. It should be noted that the flow is identical for API calls from the own code to an immediate or direct dependency, as described in the context of FIG. 5, and for API calls from the immediate dependency—or, also another transitive dependency further down in the call stack—to a transitive dependency. Hence, based on the two examples described here, the general concept is easily derivable for a person skilled in the art. For the dependency profiler, the internals of the own code and all dependencies are black boxes; it does not map API calls to transitive dependencies to certain functionality of the own code or even API calls to immediate dependencies. As further illustration, an exemplary vulnerability database entry 602 is shown on the bottom left corner of FIG. 6. It may also be noted that the “fingers” 604, particularly those pointing to the left of the dependency profiler 302 crossing the calls (symbolized by arrows) may symbolize the wrapper code of the dependency profiler 302. The arrow 606 between the vulnerability database 602 and the dependency profiler 302 is meant as a lookup operation based in which the report 304 can be generated; optionally any type of reaction type could be generated.

FIG. 7 shows a flow 700 of activities of the generated wrapper code with a blocking feature for calls of API parts with known vulnerabilities. Such blocking is one of several response actions if potential security issues exist in the chain of direct and/or indirect dependencies. Besides alerting response actions and a termination of the complete software application (product) based on renewable API calls, also the more precise response action of blocking only vulnerable API calls is possible. Instead of terminating the holds of the product, the dependency profiler could be extended to simply block the calls of API parts with known vulnerabilities.

The implementation and behavior of such blocking—shown as returning an error on the flowchart, 704—depends on the technology of the used API. E.g., if the vulnerable API part is a Java method, the wrapper code could throw a runtime exception upon invocation. The same would be done for Python functions. The wrapper code around a bash script can set the exit code to a value indicating an error. And the wrapper code around a REST API—e.g., a proxy—would return HTTP status code 503, indicating that the service is unavailable.

This extension of the generally described method would allow the software product to continue to operate with limited functionality but free of known vulnerabilities. The errors caused by blocked API call would be either handled within the call stack of the call of the blocked API calls or the error would be propagated to the user. This could, e.g., be a grayed-out “non-clickable”
i.e., disabled-dialogue button instead of an active dialogue button in a user interface.

The exception is that all dependencies and the own code implement proper error handling, either by using an alternative code path all by propagating the arrow method from the wrapper code up to the user layer. With such an error propagation, the user could receive an error message, like “<own-code-function-1> could not be used currently due to known vulnerability CV-2023-123.”

In the flowchart of FIG. 7, the first three steps are identical to those discussed in the context of FIG. 4. However, instead of continuing the flow from “dependency wrapper code set A5 to “called” in the dependency wrapper report”, 406 to the next step 408 in FIG. 4 (“dependency wrapper code calls actual API part 5 of dependency A”), the determination 702, whether the API part of A5 is vulnerable, is integrated into the flow. If that is the case—case “Y”—the dependency wrapper code returns an error code to the calling software code component, 704. If no vulnerability exists when using the API part of A5—case “N”—the remaining activities of the flow of FIG. 4—as discussed above-will be executed, namely, steps 408, 410 and 412.

It may also considered that the just described exception handling may lead to an unexpected behavior of the software product if no proper error handling is implemented. The user of the software product may be confronted with cryptic error messages the products user interface.

So, if the developers of a software product identify a certain functionality of the product as affected by known CVEs, they could insert handler code into the product's user interface that can enable blocking of certain functionality early on, namely, before the affected API parts of the vulnerable dependency are tried to be called. Thus, clear and precise error messages could be presented to the user.

This handler code could use a similar concept as the one described in the context of the alerting option if vulnerabilities exist. It could connect to an API provided by the developers of the software product where real-time information about to-be-block functionality of the software product can be retrieved.

Furthermore, and as already shortly mentioned above another extension or embodiment is also possible based on argument—and state-based assessment of vulnerabilities. Many vulnerabilities can only be exploited when vulnerable API parts are called with arguments meeting certain criteria or when the inner state of some dependent library meets some criteria that can only be reached with a certain usage pattern, e.g., a sequence of API calls with certain arguments. One example for such a CVE is described in the document CVE-2022-37434 that can be found under https://nvd.nist.com/vuln/details/CVE-2022-37434 (or https://github.com/madler/zlib/commit/eff308a), where also other examples of the security issues described here can be found.

In order to allow an assessment based on arguments and an inner state, the dependency profiler described in the context of FIG. 4 would need to be extended to record all arguments of any API calls. Based on this, a (synchronous) analysis or parsing of the recorded argument whether a certain API call can exploit a known vulnerability is performed. However, if such a call shall be blocked, it is not sufficient to record the arguments for later analysis because a decision is required immediately before the API call is forwarded from the wrapper code to the actual API.

With the described extensions, e.g., alerting based on known vulnerabilities, alerting based on a public CVE database, a termination of the software product on vulnerable API calls, and/or blocking vulnerable API calls, in place, vulnerabilities would need a machine-readable generalized description language for input data criteria and call sequences. With such information about affected arguments and call sequences, the dependency profiler could, at runtime, check the input data of any API call of any dependency whether it could be used to exploit a known vulnerability.

If, e.g., a CVE can only exploit when Cyrillic characters are sent as arguments to a function, the dependency profiler would not warn about the calls of that function if no Cyrillic characters were used as the arguments. This would allow fixing caller side vulnerabilities, where the arguments could be validated before calling a vulnerable function with those arguments. This is an important workaround, e.g., for libraries that are not maintained anymore so that they would not get any fixes for known vulnerabilities. An analysis of CVEs for different usage-patterns would need to be conducted by the open-source community and security researchers.

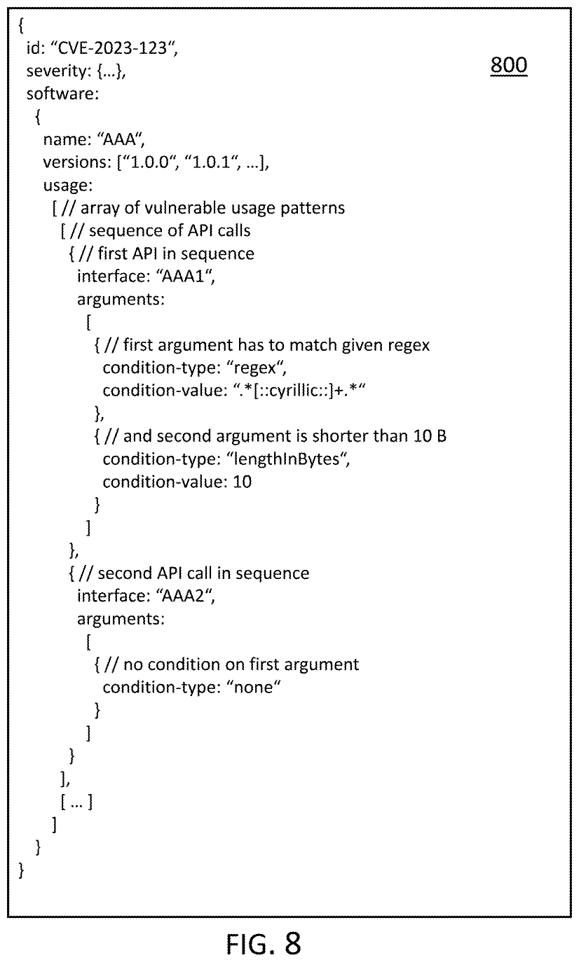

An exemplary machine-readable JSON representation 800 of such a usage-pattern could have the format as shown in FIG. 8.

Furthermore, and as an alternative of the more heavyweight argument- and/or state-based extension of the inventive method (which could also be an addition for performance-critical code paths), a more lightweight alternative based on allow-listing API parts is possible that allows fixes caller side vulnerabilities on the of API calls. If, e.g., dependency Z with vulnerable API part Z4 (compare, e.g., FIG. 2, 212, ZA) is no longer maintained, a workaround could be implemented in the own code that ensures that arguments with which Z4 are called, from the own code never exploit the known vulnerability, i.e., argument validation. The dependency profiler with any of the above discussed extensions would then continue to recognize these API calls as a vulnerability. With the extension that allows the developers to configure calls to Z4 from the own code to be secure this “noise”—i.e., false positives-could be prevented.

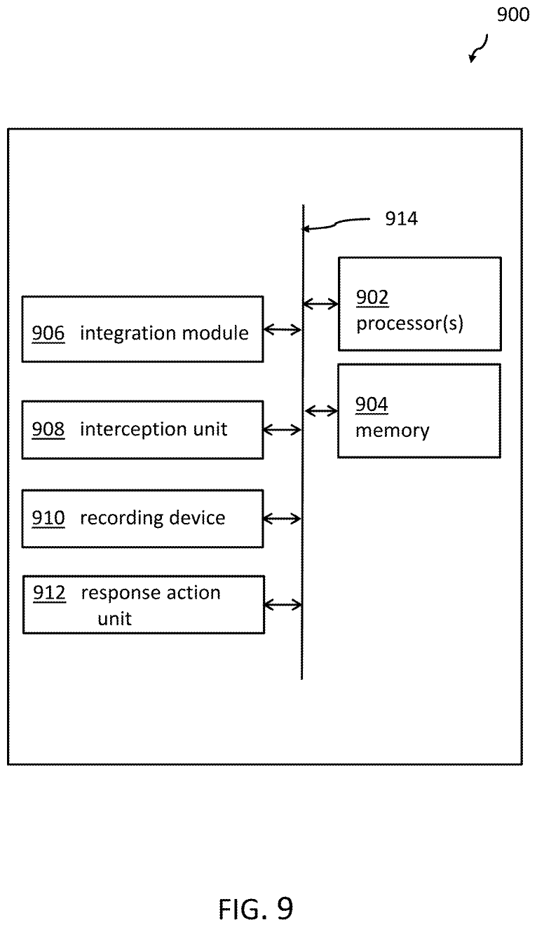

FIG. 9 shows a block diagram of an embodiment of the runtime dependency security system for protecting a software code against a security vulnerability, wherein the software code comprises at least one software code component, some of which comprising a function call to a service component, whereby each function call represents a dependency. The system comprises one or more processors 902 and a memory 904 operatively coupled to the one or more processors 902, wherein the memory stores program code portions that, when executed by the one or more processors, enable the one or more processors to integrate—in particular, by using an integration module 906—a dependency profiler with the at least one software code component, and tointercept, at runtime of the software code component—in particular, by using an interception unit 908—the function call to at least one API of the service component, thereby detecting dynamically dependencies.

The one or more processors is/are also enabled to record—in particular, using a recording device 910—sequence of usage of the detected dependencies in a profiler report, and to perform a response action—in particular by using a response action unit 912—based on known vulnerabilities in the sequence of the usage of the detected dependencies.

It shall also be mentioned that all functional units, modules, and functional blocks may be communicatively coupled to each other for signal or message exchange in a selected 1:1 manner. Alternatively, the functional units, modules and functional blocks can be linked to a system internal bus system 914 for a selective signal or message exchange. The functional units, modules and functional blocks comprise at least the one or more processors 902, the memory 904, the integration module 906, the interception unit 908, the recording device 910, and the response action unit 912. Additionally, at least the integration module 906, the interception unit 908, the recording device 910, and the response action unit 912 can be components of a hardware-oriented embodiment of the dependency profile.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

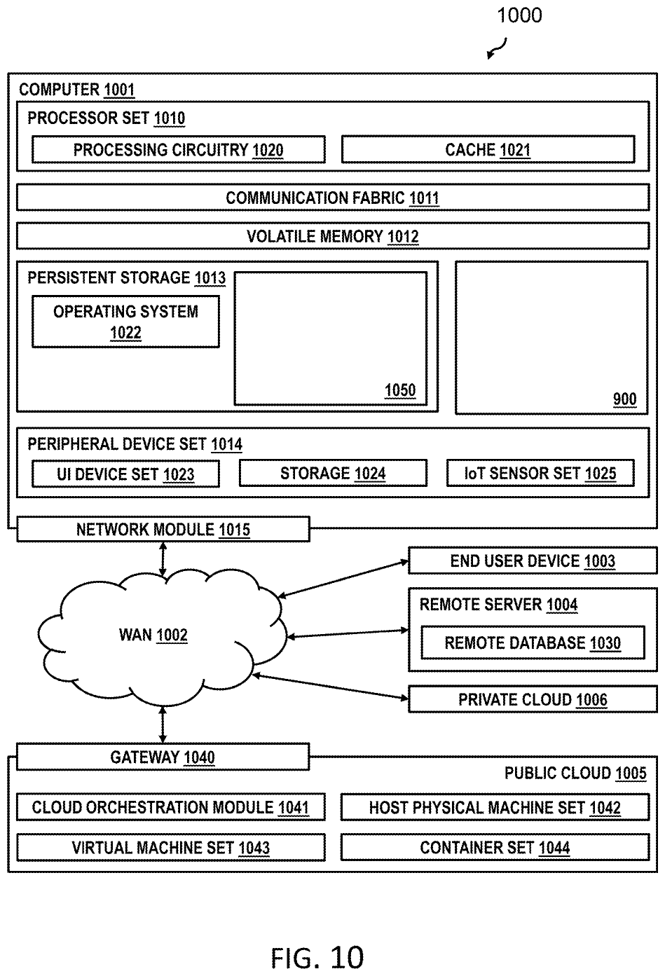

FIG. 10 shows a computing environment 1000 comprising an example of an environment for the execution of at least some of the computer code involved in performing the inventive methods, such as the code block 1050, the computer-implemented method (compare FIG. 1) for securing a software code against a security vulnerability, wherein the software code comprises at least one software code component, some of which comprising a function call, whereby each function call represents a dependency.

In addition to block 1050, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1050, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1050 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1050 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (e.g., embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

It should also be mentioned that the runtime dependency security system 900 (compare FIG. 9) for securing a software code against a security vulnerability, wherein the software code comprises at least one software code component, some of which comprising a function call to a service component, whereby each function call represents a dependency can be an operational sub-system of the computer 1001 and may be attached to a computer-internal bus system.

The terminology used herein is for the purpose of describing particular embodiments only and is not intended to limit the invention. As used herein, the singular forms a, an, and the are intended to include the plural forms as well, unless the context clearly indicates otherwise. It will further be understood that the terms comprises and/or comprising, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

The embodiments of the present invention can be summarized as follows:

1. A computer-implemented method for protecting a software code against a security vulnerability, wherein the software code comprises at least one software code component, some of which comprising a function call to a service component, whereby each function call represents a dependency, the method comprising
integrating a dependency profiler with the at least one software code component,
intercepting, at runtime of the software code component, the function call to at least one API of the service component, thereby detecting dynamically dependencies,
recording a sequence of usage of the detected dependencies in a profiler report, and
performing a response action based on known vulnerabilities in the sequence of the usage of the detected dependencies

2. The method according to clause 1, also comprising
performing the response action if the scoring value of the dependency is larger than a predefined threshold value.

3. The method according to clause 1 or 2, wherein the performing of the response action comprises
determining a reaction type dependent on the scoring value of a predefined sequence of dependencies.

4. The method according to any of the preceding clauses, also comprising
retrieving information about known vulnerabilities including information about dangerous sequences of dependencies having a potential for causing a security issue with the service component.

5. The method according to any of the preceding clauses, also comprising
retrieving information about known vulnerabilities including information about dangerous function call parameter values, each of which being indicative of a potential security issue with the service component.

6. The method according to any of the preceding clauses, also comprising
marking a service component relating to the dependency as to be updated depending on the reaction type.

7. The method according to any of the preceding clauses, wherein the integrating a dependency profiler with the at least one software code component also comprises
generating the wrapper code for a called library dynamically.

8. The system according to any of the preceding clauses, wherein the reaction type comprises at least one from the group consisting of
generating an alert,
blocking an API specific functionality of the software code component,
blocking the function call to the service component,
terminating an execution of the software code component,
marking the dependent component as “to be updated”,
changing function call parameters, thereby circumventing a vulnerability, and
changing a function call sequence, thereby circumventing a vulnerability.

9. The system according to any of the preceding clauses, wherein the dependency profiler is enabled to change function call arguments for the function call to the service component if values of the function call arguments are known to be vulnerable for the software code.

10. The system according to any of the preceding clauses, wherein the profile wrapper is enabled to change the sequence of function calls to the service component if specific sequences of function calls are known to be vulnerable for the software code.

11. The method according to clause 8, also comprising
allow-listing a function call in case a vulnerability for values of the function call arguments are known.

12. A runtime dependency security system for protecting a software code against a security vulnerability, wherein the software code comprises at least one software code component, some of which comprising a function call to a service component, whereby each function call represents a dependency, the system comprising
one or more processors and a memory operatively coupled to the one or more processors, wherein the memory stores program code portions which, when executed by the one or more processors, enable the one or more processors to
integrate a dependency profiler with the at least one software code component,
intercept, at runtime of the software code component, the function call to at least one API of the service component, thereby detecting dynamically dependencies,
record a sequence of usage of the detected dependencies in a profiler report, and
perform a response action based on known vulnerabilities in the sequence of the usage of the detected dependencies.

13. The system according to clause 12, wherein the processor is also enabled to
perform the response action if the scoring of the dependency is larger than a predefined threshold value.

14. The system according to claim 12 or 13, wherein the processor, when performing of the response action, is also enabled to
determine a reaction type depending on the scoring value of a predefined sequence of dependencies.

15. The system according to any of the clauses 12 to 14, wherein the processor is also enabled to
retrieve information about known vulnerabilities including information about dangerous sequences of dependencies having a potential for causing a security issue with the service component.

16. The system according to any of the clauses 12 to 15, wherein the processor is also enabled to
marking a service component relating to the dependency as to be updated depending on the reaction type.

17. The system according to any of the clauses 12 to 16, wherein the processor, when integrating a dependency profiler with the at least one software code component, is also enabled to
generate the wrapper code for a called library dynamically.

18. The system according to any of the clauses 12 to 17, wherein the reaction type comprises at least one from the group consisting of
generating an alert,
blocking an API specific functionality of the software code component,
blocking the function call to the service component,
terminating an execution of the software code component,
marking the dependent component as “to be updated”,
changing function call parameters, thereby circumventing a vulnerability, and
changing a function call sequence, thereby circumventing a vulnerability.

19. The system according to any of the clauses 12 to 18, wherein the processor is also enabled to
allow-list a function call in case a vulnerability for values of the function call arguments are known.

20. A computer program product for securing a software code against a security vulnerability, wherein the software code comprises at least one software code component, some of which comprising a function call to a service component, whereby each function call represents a dependency, the computer program product comprising a computer readable storage medium having program instructions embodied therewith, the program instructions being executable by one or more computing systems or controllers to cause the one or more computing systems to
integrate a dependency profiler with the at least one software code component,
intercept, at runtime of the software code component, the function call to at least one API of the service component, thereby detecting dynamically dependencies,
record a sequence of usage of the detected dependencies in a profiler report, and
perform a response action based on known vulnerabilities in the sequence of the usage of the detected dependencies.

What is claimed is:

1. A computer-implemented method for protecting a software code against a security vulnerability, wherein the software code comprises at least one software code component, some of which comprising a function call to a service component, whereby each function call represents a dependency, the method comprising:
integrating a dependency profiler with the at least one software code component;
intercepting, at runtime of the software code component, the function call to at least one API of the service component, thereby detecting dynamically dependencies;
recording a sequence of usage of the detected dependencies in a profiler report; and
performing a response action based on known vulnerabilities in the sequence of the usage of the detected dependencies.

2. The method according to claim 1, further comprising:
performing the response action if the scoring value of the dependency is larger than a predefined threshold value.

3. The method according to claim 2, wherein the performing of the response action comprises:
determining a reaction type dependent on the scoring value of a predefined sequence of dependencies.

4. The method according to claim 1, further comprising:
retrieving information about known vulnerabilities including information about dangerous sequences of dependencies having a potential for causing a security issue with the service component.

5. The method according to claim 1, further comprising:
retrieving information about known vulnerabilities including information about dangerous function call parameter values, each of which being indicative of a potential security issue with the service component.

6. The method according to claim 1, further comprising:
marking a service component relating to the dependency as to be updated depending on the reaction type.

7. The method according to claim 1, wherein the integrating a dependency profiler with the at least one software code component further comprises:
generating the wrapper code for a called library dynamically.

8. The method according to claim 1, wherein the reaction type comprises at least one from the group consisting of:
generating an alert;
blocking an API specific functionality of the software code component;
blocking the function call to the service component;
terminating an execution of the software code component;
marking the dependent component as “to be updated”;
changing function call parameters, thereby circumventing a vulnerability; and
changing a function call sequence, thereby circumventing a vulnerability.

9. The method according to claim 1, wherein the dependency profiler changes function call arguments for the function call to the service component based on values of the function call arguments being known to be vulnerable for the software code.

10. The method according to claim 1, wherein the profile wrapper changes the sequence of function calls to the service component based on specific sequences of function calls being known to be vulnerable for the software code.

11. The method according to claim 8, further comprising:
allow-listing a function call in case a vulnerability for values of the function call arguments are known.

12. A runtime dependency security computer system for protecting a software code against a security vulnerability, the system comprising:
one or more processors and a memory operatively coupled to the one or more processors, wherein the memory stores program code portions which, when executed by the one or more processors, enable the one or more processors to:
integrate a dependency profiler with the at least one software code component;
intercept, at runtime of the software code component, the function call to at least one API of the service component, thereby detecting dynamically dependencies;
record a sequence of usage of the detected dependencies in a profiler report; and
perform a response action based on known vulnerabilities in the sequence of the usage of the detected dependencies.

13. The computer system according to claim 12, wherein the processor performs the response action based on the scoring of the dependency being larger than a predefined threshold value.

14. The computer system according to claim 12, wherein the processor performs the response action:
determine a reaction type depending on the scoring value of a predefined sequence of dependencies.

15. The computer system according to claim 12, wherein the processor:
retrieves information about known vulnerabilities including information about dangerous sequences of dependencies having a potential for causing a security issue with the service component.

16. The computer system according to claim 12, wherein the processor marks a service component relating to the dependency as to be updated depending on the reaction type.

17. The computer system according to claim 12, wherein the processor, when integrating a dependency profiler with the at least one software code component, generates the wrapper code for a called library dynamically.

18. The computer system according to claim 12, wherein the reaction type comprises at least one from the group consisting of:
generating an alert;
blocking an API specific functionality of the software code component;
blocking the function call to the service component;
terminating an execution of the software code component;
marking the dependent component as “to be updated”;
changing function call parameters, thereby circumventing a vulnerability; and
changing a function call sequence, thereby circumventing a vulnerability.

19. The computer system according to claim 12, wherein the processor is also enabled to:
allow-list a function call in case a vulnerability for values of the function call arguments are known.

20. A computer program product for securing a software code against a security vulnerability, wherein the software code comprises at least one software code component, some of which comprising a function call to a service component, whereby each function call represents a dependency:
the computer program product comprising a computer readable storage medium having program instructions embodied therewith, the program instructions being executable by one or more computing systems or controllers to cause the one or more computing systems to:
integrate a dependency profiler with the at least one software code component;
intercept, at runtime of the software code component, the function call to at least one API of the service component, thereby detecting dynamically dependencies;
record a sequence of usage of the detected dependencies in a profiler report; and
perform a response action based on known vulnerabilities in the sequence of the usage of the detected dependencies.
